(19) United States
(12) Patent Application Publication
(10) Pub. No.: US 2025/0034835 A1
(43) Pub. Date: Jan. 30, 2025

(54) MOLDBOARD MODULAR RAIL DESIGN

(71) Applicant: Caterpillar Inc., Peoria, IL (US)

(72) Inventors: Bruce Raymond VAHLING, Urbana, IL (US); Nathaniel K. HARSHMAN, Sullivan, IL (US); Benjamin J. KOVALICK, Chillicothe, IL (US)

(73) Assignee: Caterpillar Inc., Peoria, IL (US)

(21) Appl. No.: 18/225,867

(22) Filed: Jul. 25, 2023

(51) Int. Cl. E02F 3/76; E02F 3/815

(52) U.S. Cl. CPC E02F 3/7663; E02F 3/815

(57) ABSTRACT

A moldboard assembly and method of reinforcing a moldboard assembly is disclosed. The moldboard assembly may comprise a moldboard including a front and a back, an upper rail and a lower rail spaced apart from the upper rail, and a back plate. The upper rail and the lower rail each may be mounted to and extend lengthwise across the back of the moldboard. The upper rail may be oriented to slope upward at a first angle from a vertical plane, and the lower rail may be oriented to slope downward at a second angle from the vertical plane. Each of the upper rail and lower rail include a top, a bottom, an inner side and an outer side disposed opposite to the inner side. The back plate may be mounted to the inner side of the upper rail and to the inner side of the lower rail.

### TECHNICAL FIELD

The present disclosure generally relates to moldboards, and more particularly, for moldboards on motor graders.

### BACKGROUND

The manufacturing of moldboards can be time consuming and costly. Furthermore, over time, wear and tear from use can affect the upper and lower rails that are mounted on back of the moldboard. Replacement of moldboards can also be very time consuming, making a field or maintenance shop replacement challenging.

U.S. Pat. No. 7,650,949, issued Jan. 26, 2010, discloses a moldboard of a work vehicle that comprises a blade and a sideshift rail comprising a bar attached to the blade and a wear strip removably mounted to the bar. While beneficial, a better arrangement is needed.

### SUMMARY OF THE DISCLOSURE

In one aspect of the present disclosure, a moldboard assembly is disclosed. The moldboard assembly may comprise a moldboard including a front and a back, an upper rail and a lower rail spaced apart from the upper rail, and a back plate. The upper rail and the lower rail each may be mounted to and extend lengthwise across the back of the moldboard. The upper rail may be oriented to slope upward at a first angle from a vertical plane, and the lower rail may be oriented to slope downward at a second angle from the vertical plane. Each of the upper rail and lower rail include a top, a bottom, an inner side and an outer side disposed opposite to the inner side. The back plate may be mounted to the inner side of the upper rail and to the inner side of the lower rail.

In another aspect of the disclosure a method of reinforcing a moldboard assembly is disclosed. The method may comprise: boring a plurality of rail bores in an upper rail and in a lower rail mounted to the back of a moldboard; positioning a first rail segment on the upper rail and aligning a plurality of segment bores in the first rail segment with some of the plurality of rail bores in the upper rail to form a first plurality of channels that extend from the outer side of the upper rail to an inner-side-face of the first rail segment; and securing the first rail segment to the upper rail with a first plurality of fasteners, each fastener of the first plurality of fasteners disposed in the first plurality of channels in a one-to-one correspondence. In an embodiment, the upper rail and the lower rail may be each made of steel and may be each free of heat treatment, and the first and second rail segments may be made of a heat treated material.

In yet another aspect of the disclosure, a moldboard assembly is disclosed. The moldboard assembly may comprise: a moldboard including a front and a back, an upper rail and a lower rail spaced apart from the upper rail, a back plate and a plurality of spaced-apart gussets. The upper rail and lower rail may each be mounted to and extend lengthwise across the back of the moldboard. A height of the upper rail may extend away from the back of the moldboard. A height of the lower rail may extend away from the back of the moldboard. The upper rail may be oriented to slope upward at a first angle from a vertical plane. The lower rail may be oriented to slope downward at a second angle from the vertical plane. Wherein, the first angle may be in the range of 30-60 degrees from the vertical plane and the second angle may be in the range of 30-60 degrees from the vertical plane. Each of the upper rail and lower rail may include a top, a bottom, an inner side and an outer side disposed opposite to the inner side. The back plate may be mounted to and extend from the inner side of the upper rail and to the inner side of the lower rail. The plurality of spaced-apart gussets may be disposed along the outer side of the upper rail.

### BRIEF DESCRIPTION OF THE DRAWINGS

FIG. 1 is a side view of an exemplary machine that includes a moldboard utilizing the teachings of this disclosure;

FIG. 2 is a perspective view of an embodiment of the blade of the exemplary machine of FIG. 1;

FIG. 3 illustrates a side view of the embodiment of FIG. 2;

FIG. 4 illustrates the view of FIG. 3 with the end cap removed;

FIG. 5 is a perspective view showing the upper and lower rails with rail bores;

FIG. 6 is a perspective view of another embodiment of the moldboard assembly;

FIG. 7 illustrates a side view of the embodiment of FIG. 6; and

FIG. 8 illustrates a section view of the embodiment of FIG. 6 taken along the lines of 8-8.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts, unless otherwise specified.

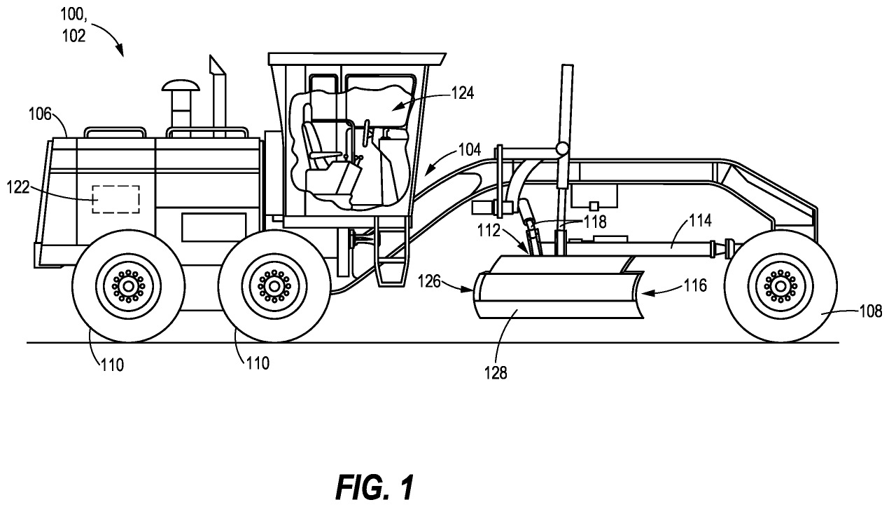

FIG. 1 illustrates one example of a machine 100 that incorporates the features of the present disclosure. The exemplary machine 100 may be a vehicle such as motor grader 102. While the following detailed description and drawings are made with reference to a motor grader 102 as the exemplary machine 100, the teachings of this disclosure may be employed on other machines 100 that include a moldboard assembly 126, including but not limited to, tractors, skid steer loaders or dozers.

The motor grader 102 may include a front frame 104 pivotally coupled to a rear frame 106 by a hitch (not shown), which facilitates steering of the front frame 104 relative to the rear frame 106. The motor grader 102 may further include front wheels 108 and a pair of tandem rear wheels 110. A circle drive gear 112 may be supported by a draw bar 114 connected to the front frame 104. A portion of the circle drive gear 112 may be configured to extend downwardly to pivotally support a blade 116. The blade 116 may be moved or adjusted to obtain a range of different positions and angles by way of the circle drive gear 112 and a pair of lift actuators 118 and a tilt actuator (not shown) mounted on the front frame 104.

The rear frame 106 of the motor grader 102 may house an engine 122 and other power train components (not shown) for generating and delivering power to operate the motor grader 102. The engine 122 may be any of a gasoline, diesel, or any other engine 122 employed with such machines 100. The motor grader 102 may even draw power from other power sources, such as natural gas, fuel cells, batteries, etc. Relatedly, while the transmission (not shown) of the motor grader 102 may typically be a continuous variable transmission (CVT), in at least some embodiments, the transmission may be any of a variety of types that are commonly employed in work or construction machines. For example, in some embodiments, the transmission may be automatic, semi-automatic, manual, direct-drive, or any transmission having a variable output or modulated gear ratio.

An operator compartment 124 is disposed on a rear portion of the front frame 104. The operator compartment 124 is configured to house control levers, joysticks, push buttons, and other types of control elements typically known in the art for actuating an operation of the motor grader 102. In an embodiment, the operator compartment 124 may be a cab. In other embodiments, the operator compartment 124 may not enclose the operator but may instead be open to the environment with a roll-over-protection (ROP) apparatus (not shown) (e.g., a roll-cage or the like) visible.

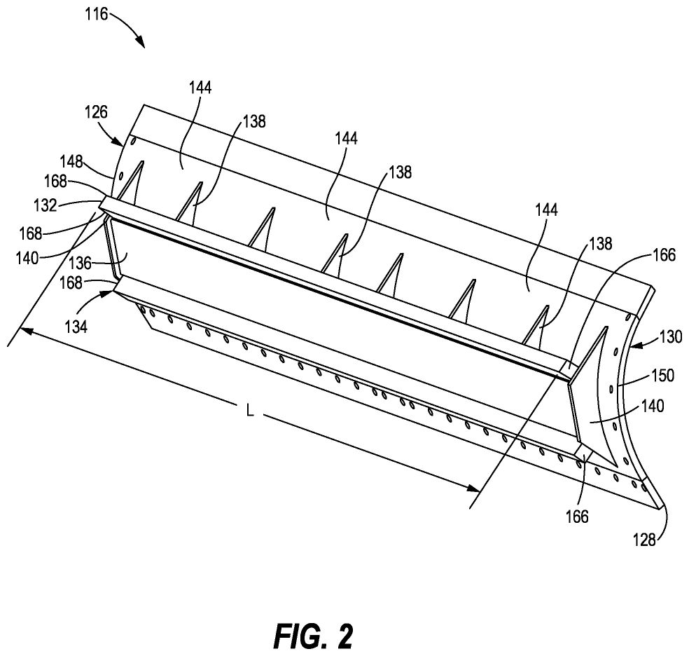

FIG. 2 illustrates one embodiment of the blade 116. In the embodiment, the blade 116 includes a moldboard assembly 126 and a cutting edge 128. The moldboard assembly 126 includes moldboard 130, an upper rail 132, a lower rail 134 and a backplate 136. The moldboard assembly 126 may further include one or more gussets 138 and/or one or more end caps 140. The cutting edge 128 (FIG. 2) is coupled to a lower part of the moldboard 130.

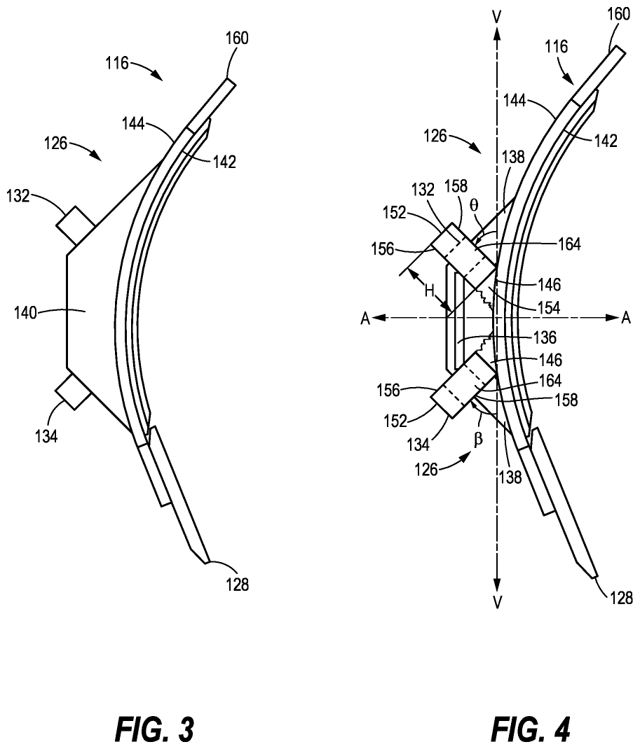

The moldboard 130 includes a front 142 (FIGS. 3-4) and a back 144 (FIG. 2). In an embodiment, the moldboard 130 may have a curved profile when viewed from the side of the blade 116 (best seen in FIG. 3).

The upper rail 132 (FIG. 2) is mounted to the back 144 of the moldboard 130. As best seen in FIG. 4, in an embodiment, the upper rail 132 may be mounted to the back 144 of the moldboard 130 by a welded joint 146 (upper rail 132 welded to the back 144 of the moldboard 130). As shown in FIG. 2, the upper rail 132 extends between the left edge 148 and right edge 150 of the back 144 of the moldboard 130 and is oriented so that the length L of the upper rail 132 runs lengthwise across the back 144 of the moldboard 130. As shown in FIG. 4, the height H of the upper rail 132 extends away from back 144 of the moldboard 130 such that the upper rail 132 is oriented to slope upward from the back 144 of the moldboard 130 at a first angle θ from a vertical plane V. In an embodiment, the first angle θ may be in the range of about 30 to about 60 degrees from the vertical plane V (FIG. 4). In another embodiment, the first angle θ may be in the range of about 40 to about 50 degrees from the vertical plane V, or may be about 45 degrees from the vertical plane V.

The lower rail 134 is mounted to the back 144 of the moldboard 130 and spaced apart from the upper rail 132. The lower rail 134 is disposed proximal to the cutting edge 128, as compared to the upper rail 132, which is disposed distal from the cutting edge 128. Similar to the upper rail 132, in an embodiment, the lower rail 134 may be mounted to the back 144 of the moldboard 130 by a welded joint 146 (lower rail 134 welded to the back 144 of the moldboard 130). The lower rail 134 extends between the left edge 148 (FIG. 2) and right edge 150 of the moldboard 130 and is oriented so that the comparable length L of the lower rail 134 runs lengthwise across the back 144 of the moldboard 130. Similar to the upper rail 132, the height H of the lower rail 134 extends away from back 144 of the moldboard 130 such that the lower rail 134 is oriented to slope downward from the back 144 of the moldboard 130 at a second angle β from the vertical plane V, as shown in FIG. 4. In an embodiment, the second angle β may be in the range of about 30 to about 60 degrees from the vertical plane V. In another embodiment, the second angle β may be in the range of about 40 to about 50 degrees from the vertical plane V, or may be about 45 degrees from the vertical plane V.

Each of the upper rail 132 and the lower rail 134 includes a top 152, a bottom 154, an inner side 156, an outer side 158 disposed opposite to the inner side 156, a first end 166 and a second end 168. The bottom 154 is generally oriented proximal to the back 144 of the moldboard 130. The top 152 is generally oriented to face outward from the back 144 of the moldboard 130. The outer side 158 is generally oriented to face toward a top edge 160 of the moldboard 130, and the inner side 156 is opposite to the outer side 158 and is disposed adjacent to the back plate 136.

In an embodiment, each of the upper and lower rails 132, 134 may be made of steel. The steel may be free of heat treatment or may be heat treated.

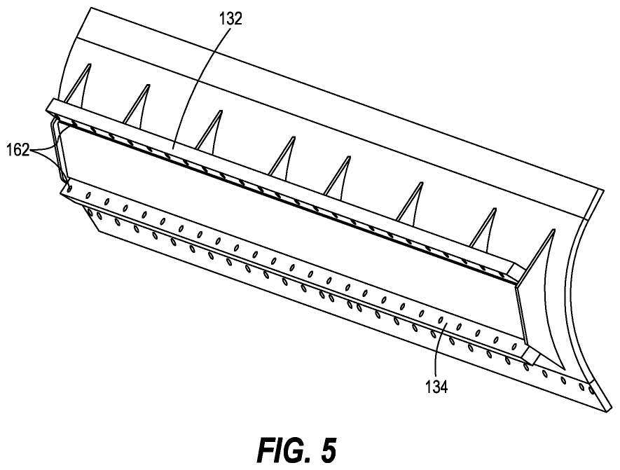

In some embodiments (for example, the embodiment shown in FIG. 2), but not all embodiments, the upper rail 132 and/or lower rail 134 may be free of rail bores 162 (seen in FIG. 5 and discussed later herein).

A plurality of spaced-apart gussets 138 may be disposed along the outer side 158 of the upper rail 132 (FIGS. 2 and 4) and/or along the outer side 158 of the lower rail 134 (FIG. 4). The gusset 138 may be disposed between the back 144 of the moldboard 130 and the outer side 158 of the upper rail 132 and/or the outer side 158 of the lower rail 134. The gusset 138 may be mounted on the back 144 of the moldboard 130 and mounted to the upper rail 132 and/or lower rail 134. In the embodiment of FIG. 2, the gussets 138 are disposed along the upper rail 132 and the lower rail 134 (best seen FIG. 4) and are generally plate-like. The gusset 138 is configured to brace the associated upper rail 132 or lower rail 134 on which it is mounted.

The backplate 136 is disposed between the upper rail 132 and the lower rail 134. In an embodiment, the back plate 136 may be generally parallel to the vertical plane V, and may be transverse or perpendicular to a horizontal plane A. In an embodiment, the back plate 136 extends from the inner side 156 of the upper rail 132 to the inner side 156 of the lower rail 134. In an embodiment, the back plate 136 may be mounted or coupled to the inner side 156 of the upper rail 132 and to the inner side 156 of the lower rail 134. In some embodiments, the back plate 136 may be adjacent to a mid-section 164 of the inner side 156 of the upper rail 132 and/or lower rail 134, as shown in FIG. 4.

An endcap 140 (FIG. 2) may be mounted to the back 144 of the moldboard 130. A first endcap 140 may be mounted adjacent to the first end 166 of the upper rail 132 and to the first end 166 of the lower rail 134. A second endcap 140 may be mounted adjacent to the second end 168 of the upper rail 132 and the second end 168 of the lower rail 134.

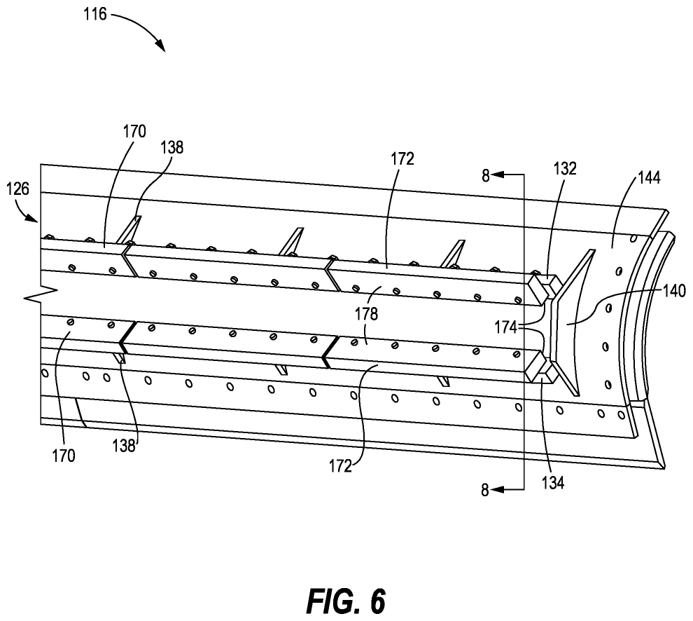

FIGS. 6-8 illustrate another embodiment, which is the same as the embodiment of FIGS. 2-4 except that the upper rail 132 and lower rail 134 may each include rail bores 162 (best seen in FIG. 5) and the moldboard assembly 126 (FIGS. 6-8) includes a plurality of rail segments 170. As shown in FIG. 8, the upper rail 132 may further include a plurality of rail bores 162 that extend therethrough from the outer side 158 to the inner side 156 of the upper rail 132. Similarly the lower rail 134 may further include a plurality of rail bores 162 that extend therethrough from the outer side 158 to the inner side 156 of the lower rail 134.

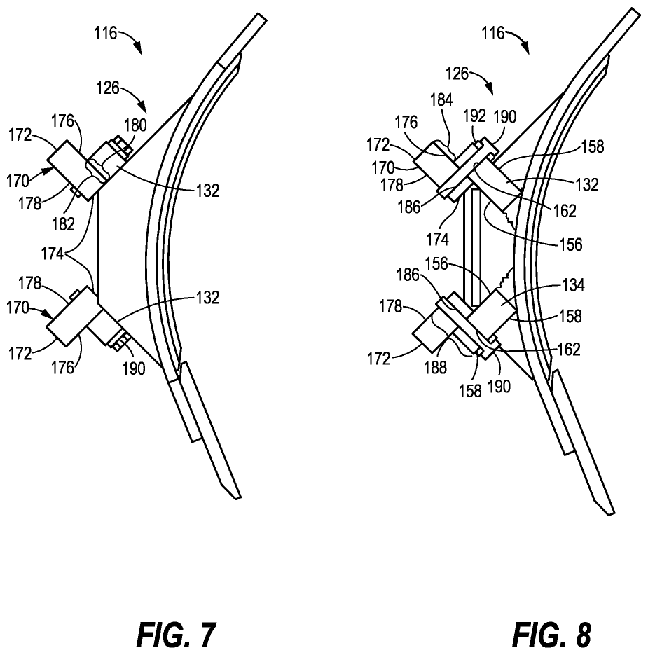

As noted above, in the embodiment of FIGS. 6-8, the moldboard assembly 126 further includes the plurality of rail segments 170. A first portion of the plurality of rail segments 170 may be mounted to the upper rail 132 and configured to reinforce the upper rail 132, and a second portion of the plurality of rail segments 170 may be mounted to the lower rail 134 and configured to reinforce the lower rail 134. As shown in FIG. 7, each rail segment 170 includes a top-face 172, a bottom-face 174, an outer-side-face 176 and an inner-side-face 178.

A first part 182 (FIG. 8) of the outer-side-face 176 of a first rail segment 170 is overlappingly mounted on an upper portion 180 (generally proximal to the top-face 172) of the inner side 156 (FIG. 8) of the upper rail 132, and a second part 184 of the outer-side-face 176 extends outward and away from the upper rail 132 and is free of the inner side 156 the upper rail 132.

As discussed above, the upper rail 132 and/or lower rail 134 may further include a plurality of rail bores 162 extending therethrough. Each rail segment 170 may include a plurality of segment bores 186 extending therethrough. The plurality of rail bores 162 and plurality of segment bores 186 may be aligned in a one-to-one correspondence to form a plurality of channels 188, each channel 188 extending from the outer side 158 of the respective upper rail 132 or lower rail 134 to the an inner-side-face 178 of the rail segment 170. In an embodiment, one or more of the rail bores 162 may include threads. The moldboard assembly 126 may further comprise a plurality of fasteners 190 (for example bolts, screws or the like). The fastener 190 is disposed in a channel 188 of the plurality of channels 188. In one embodiment, the fastener 190 may be in securing engagement with threads in the rail bore. In an embodiment, the fastener 190 may also be received by and in locking engagement with a lock member 192 (e.g., a nut or the like). The fastener 190 alone or fastener 190 and lock member 192 together (in locking engagement) are configured to secure the rail segment 170 to the respective upper rail 132 or lower rail 134. In an embodiment, the fastener 190 may extend from the outer side 158 of the rail 132/134 to the inner-side-face 178 of the rail segment 170. In another embodiment, the fastener 190 may extend from the inner-side-face 178 of the rail segment 170 to the outer side 158 of the rail 132/134. In an embodiment, one or more rail segments 170 may be made of a heat treated material, for example, heat treated steel.

In the embodiment shown in FIGS. 6-8, the back plate 136 is disposed between the bottom-face 174 of the rail segment 170 and the inner side 156 of the upper rail 132 or lower rail 134 to which the rail segment 170 mounted. The back plate 136 is also disposed between rail segment 170 mounted to the upper rail 132 and the rail segment 170 mounted to the lower rail 134. The back plate 136 is also disposed between the rail segment 170 and the back 144 of the moldboard 130.

Also disclosed is a method of reinforcing a moldboard assembly 126. The method may comprise: mounting (e.g., welding) lengthwise an upper rail 132 and a lower rail 134 to the back 144 of a moldboard 130, wherein the upper rail 132 is oriented to slope upward at a first angle θ from a vertical plane V, and the lower rail 134 is oriented to slope downward at a second angle β from the vertical plane, each of the upper rail 132 and lower rail 134 including a top 152, a bottom 154, an inner side 156 and an outer side 158 disposed opposite to the inner side 156; and mounting a back plate 136 to the inner side 156 of the upper rail 132 and to the inner side 156 of the lower rail 134, wherein the back plate 136 is disposed between the upper rail 132 and the lower rail 134. In an embodiment, the upper rail 132 and/or lower rail 134 may be made of a material (e.g., steel) that may be free of heat treatment, or may have been heat treated.

The method may further comprise boring a plurality of rail bores 162 in the upper rail 132 and in a lower rail 134 mounted to the back 144 of a moldboard 130, and positioning a first rail segment 170 on the upper rail 132 and aligning a plurality of segment bores 186 in the first rail segment 170 with some of the plurality of rail bores 162 in the upper rail 132 to form a first plurality of channels 188 that extend from the outer side 158 of the upper rail 132 to an inner-side-face 178 of the first rail segment 170; and securing the first rail segment 170 to the upper rail 132 with a first plurality of fasteners 190, each fastener 190 of the first plurality disposed in the first plurality of channels 188 in a one-to-one correspondence.

The method may further comprise positioning a second rail segment 170 on the lower rail 134 and aligning a plurality of segment bores 186 in the second rail segment 170 with some of the plurality of rail bores 162 in the lower rail 134 to form a second plurality of channels 188 that extend from the outer side 158 of the lower rail 134 to the an inner-side-face 178 of the second rail segment 170; securing the second rail segment 170 to the lower rail 134 with a second plurality of fasteners 190, each fastener 190 of the second plurality disposed in the second plurality of channels 188 in a one-to-one correspondence; and mounting a back plate 136 to the inner side 156 of the upper rail 132 and to the inner side 156 of the lower rail 134, wherein the back plate 136 is disposed between the first rail segment 170 and the upper rail 132, and between a second rail segment 170 and the lower rail 134. In an embodiment the first rail segment 170 and/or second rail segment 170 may be made of a heat treated material.

### INDUSTRIAL APPLICABILITY

In general, the foregoing disclosure finds utility in machines 100, for example motor graders 102, that have a blade 116 that includes a moldboard assembly 126. A low-cost may be achieved by providing the moldboard assembly 126 with the upper rail 132 and lower rail 134 without heat treatment. For reinforcement, but at added cost, hardened rail segments 170 with heat treatment may be attached to the upper rail 132 and lower rail 134. For example, a user may desire to reinforce the upper rail 132 and/or lower rail 134 of an embodiment of the moldboard assembly 126 that does not initially include rail segments 170 (e.g., the embodiment of FIGS. 2-4). The method to reinforce such a moldboard assembly 126 may comprise boring a plurality of rail bores 162 in the upper rail 132 and/or in the lower rail 134 mounted to the back 144 of the moldboard 130 (see FIG. 5). In an embodiment, the upper rail 132 and/or lower rail 134 may be made of a material (e.g., steel) that may be free of heat treatment, or may have been heat treated. The method may further comprise positioning one or more rail segments 170 on the upper rail 132 and/or lower rail 134, and aligning the segment bores 186 in each such rail segment 170 with some of the plurality of rail bores 162 in the upper rail 132 or lower rail 134 (to which the rail segment 170 will be coupled) to form a plurality of channels 188 that each extend from the outer side 158 of the associated upper rail 132 or lower rail 134 to the inner-side-face 178 of the rail segment 170. The method may further comprise securing the rail segment 170 to the respective upper rail 132 or lower rail 134 with a plurality of fasteners 190, the fasteners 190 of the plurality disposed at least partially in the plurality of channels 188. In an embodiment the rail segment 170 may be made of a heat treated material.

Also, a user may desire to replace one or more rail segments 170 that have been mounted to the upper rail 132 and/or lower rail 134 of an embodiment of the moldboard assembly 126 that initially included rail segments 170 (e.g., the embodiment of FIGS. 6-8) or that subsequently had rail segments 170 installed/mounted to the upper rail 132 or lower rail 134. To do so, the fasteners 190 may be loosened or unlocked from the lock member 192 and/or removed (if desired) entirely or partially from the associated channels 188, and the rail segment 170 being replaced may be detached from the associated upper rail 132 or lower rail 134 and replaced with another rail segment 170. The fasteners 190 may then be tightened or placed in locking engagement with the respective lock member 192 to secure the new rail segment 170 to the respective upper rail 132 or lower rail 134. Because there may be multiple rail segments 170 per upper rail 132 or lower rail 134, a user may replace a single rail segment 170, if desired (e.g., when one has experienced more wear than the others), or, if desired, more than one rail segment 170.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A moldboard assembly comprising:
a moldboard including a front and a back;
an upper rail and a lower rail spaced apart from the upper rail, the upper rail and the lower rail each mounted to and extending lengthwise across the back of the moldboard, the upper rail oriented to slope upward at a first angle from a vertical plane, the lower rail oriented to slope downward at a second angle from the vertical plane, each of the upper rail and lower rail including:
a top;
a bottom;
an inner side; and
an outer side disposed opposite to the inner side; and
a back plate mounted to the inner side of the upper rail and to the inner side of the lower rail.

2. The moldboard assembly of claim 1, wherein the upper rail and the lower rail are made of a material that is free of heat treatment.

3. The moldboard assembly of claim 1, wherein the upper rail or the lower rail is mounted to the back of the moldboard.

4. The moldboard assembly of claim 3, wherein the upper rail or the lower rail is mounted to the back of the moldboard by a welded joint.

5. The moldboard assembly of claim 1 further comprising a plurality of spaced-apart gussets disposed along the outer side of the upper rail.

6. The moldboard assembly of claim 1 further comprising a first rail segment mounted to the inner side of the upper rail and a second rail segment mounted to the inner side of the lower rail, wherein the first rail segment is configured to reinforce the upper rail and the second rail segment is configured to reinforce the lower rail.

7. The moldboard assembly of claim 6, wherein the first rail segment or the second rail segment is made of a heat treated material.

8. The moldboard assembly of claim 6, wherein the back plate is disposed between the first rail segment and the upper rail, and between the second rail segment and the lower rail.

9. A method of reinforcing a moldboard assembly, the method comprising:
boring a plurality of rail bores in an upper rail and in a lower rail mounted to the back of a moldboard;
positioning a first rail segment on the upper rail and aligning a plurality of segment bores in the first rail segment with some of the plurality of rail bores in the upper rail to form a first plurality of channels that extend from the outer side of the upper rail to an inner-side-face of the first rail segment; and
securing the first rail segment to the upper rail with a first plurality of fasteners, each fastener of the first plurality of fasteners disposed in the first plurality of channels in a one-to-one correspondence,
wherein the upper rail and the lower rail are each made of steel and are each free of heat treatment, and the first and second rail segments are made of a heat treated material.

10. The method of claim 9 further comprising:
mounting lengthwise an upper rail and a lower rail to the back of the moldboard, wherein the upper rail is oriented to slope upward at a first angle from a vertical plane, and the lower rail is oriented to slope downward at a second angle from the vertical plane, each of the upper rail and the lower rail including a top, a bottom, an inner side and an outer side disposed opposite to the inner side; and
mounting a back plate to the inner side of the upper rail and to the inner side of the lower rail, wherein the back plate is disposed between the upper rail and the lower rail.

11. The method of claim 9, wherein the upper rail and the lower rail are welded to the back of the moldboard.

12. The method of claim 9, further comprising:
positioning a second rail segment on the lower rail and aligning a plurality of segment bores in the second rail segment with some of the plurality of rail bores in the lower rail to form a second plurality of channels that extend from the outer side of the lower rail to an inner-side-face of the second rail segment,
securing the second rail segment to the lower rail with a second plurality of fasteners, each fastener of the second plurality disposed in the second plurality of channels in a one-to-one correspondence; and
mounting a back plate to the inner side of the upper rail and to the inner side of the lower rail, wherein the back plate is disposed between the first rail segment and the upper rail, and between a second rail segment and the lower rail.

13. A moldboard assembly comprising:
a moldboard including a front and a back;
an upper rail and a lower rail spaced apart from the upper rail, the upper rail and lower rail each mounted to and extending lengthwise across the back of the moldboard, a height of the upper rail extending away from the back of the moldboard, a height of the lower rail extending away from the back of the moldboard, the upper rail oriented to slope upward at a first angle from a vertical plane, the lower rail oriented to slope downward at a second angle from the vertical plane, wherein the first angle is in a first range of 30-60 degrees from the vertical plane and the second angle is in a second range of 30-60 degrees from the vertical plane, each of the upper rail and lower rail including:
a top;
a bottom;
an inner side; and
an outer side disposed opposite to the inner side; and
a back plate mounted to and extending from the inner side of the upper rail and to the inner side of the lower rail; and
a plurality of spaced-apart gussets disposed along the outer side of the upper rail.

14. The moldboard assembly of claim 13, wherein the back plate is mounted to a first mid-section of the inner side of the upper rail and to a second mid-section of the inner side of the lower rail, wherein the back plate is transverse to a horizontal plane.

15. The moldboard assembly of claim 13, wherein the upper rail and the lower rail are each made of steel and are each free of heat treatment.

16. The moldboard assembly of claim 13, wherein the upper rail or the lower rail are mounted to the back of the moldboard by a welded joint.

17. The moldboard assembly of claim 13 further comprising a plurality of rail segments, a first portion of the plurality of rail segments mounted to the upper rail and configured to reinforce the upper rail, and a second portion of the plurality of rail segments mounted to the lower rail and configured to reinforce the lower rail, wherein at least one of rail segments is made of a heat treated material.

18. The moldboard assembly of claim 13, in which each rail segment includes:
a top-face;
a bottom-face;
an outer-side-face; and
an inner-side-face,
wherein a first part of the outer-side-face of a first rail segment is overlappingly mounted on an upper portion of the inner side of the upper rail, and a second part of the outer-side-face extends outward and away from the upper rail.

19. The moldboard assembly of claim 18, in which the upper rail further includes a plurality of rail bores extending therethrough, and the first rail segment includes a plurality of segment bores extending therethrough, the plurality of rail bores and plurality of segment bores aligned in a one-to-one correspondence to form a plurality of channels, each channel extending from the outer side of the upper rail to the an inner-side-face of the first segment, the moldboard assembly further comprising a plurality of fasteners, each fastener disposed in one channel of the plurality of channels.

20. The moldboard assembly of claim 17, wherein the back plate is disposed between a first rail segment and the upper rail, and between a second rail segment and the lower rail
